(19) United States
(12) Patent Application Publication
(10) Pub. No.: US 2009/0165112 A1
(43) Pub. Date: Jun. 25, 2009

(54) METHODS AND APPARATUSES FOR USING CONTENT, CONTROLLING USE OF CONTENT IN CLUSTER, AND AUTHENTICATING AUTHORIZATION TO ACCESS CONTENT

(75) Inventors: Hyug-rae Cho, Seoul (KR); Du-na Oh, Seoul (KR); Myeong-wuk Jang, Seoul (KR); Min-kyu Lee, Yongin-si (KR); Sei-ie Jang, Yongin-si (KR); Hyun-ju Shim, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/135,260

(22) Filed: Jun. 9, 2008

(30) Foreign Application Priority Data
Dec. 21, 2007 (KR) 10-2007-0135244

(51) Int. Cl. G06F 7/04

(52) U.S. Cl. 726/9

(57) ABSTRACT

Provided is a method of controlling use of content in a cluster by a source device, the method including receiving a request from a sync device to transmit content, authenticating an authorization of the sync device to access the content, and transmitting a stream of the content to the sync device. Thus, copyrights of content used by the source device or the sync device of the home network can be efficiently protected.

### CROSS-REFERENCE TO RELATED PATENT APPLICATION

This application claims priority from Korean Patent Application No. 10-2007-0135244, filed on Dec. 21, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to a home network, and more particularly, to using and controlling use of content in a cluster, authenticating an authorization to access content, and a computer readable medium having recorded thereon the above methods, for preventing illegal spread of content in a home network.

2. Description of the Related Art

Due to dramatic technical developments in home networks and broadcasting, supply and demand for high definition (HD) contents are increasing. As the demand for HD contents increases, a demand for technologies protecting copyrights of the HD contents is also increasing.

FIG. 1 is a diagram of a related system for controlling use of content in a cluster.

Referring to FIG. 1, the related system controlling use of content in a cluster includes a cluster A 110 and a cluster B 130. A cluster denotes a plurality of apparatuses belonging to a single home network. The cluster A 110 includes apparatuses 120 connected to each other, while the cluster B 130 includes other apparatuses 140 connected to each other.

Content is used in a cluster. For example, the apparatuses 120 belonging to the cluster A 110 are authorized to access content A 150, while the apparatuses 140 belonging to the cluster B 130 are not authorized to access the content A 150. Information of clusters in which contents are used can be managed as metadata of contents.

Before managing the information of clusters in which contents are used as metadata of contents, all apparatuses should import information of other apparatuses in same cluster, and should encrypt contents based on the information or should manage encryption keys. However, since such methods are well known in the art, detailed descriptions will be omitted. To summarize, an authorization to use content is issued based on a cluster to which a playback apparatus of the content belongs.

FIG. 2 is a diagram for explaining problems of the related system for controlling use of content in a cluster.

As home network technologies are developed, it is common nowadays that apparatuses for storing contents (referred to as ‘source devices’ hereinafter), such as a first personal video recorder (PVR1) 220 and a second personal video recorder (PVR2) 250, and apparatuses for playing contents back (referred to as ‘sync devices’ hereinafter), such as a first digital television (DTV1) 230 and a second digital television (DTV2) 260 exist separately. The PVR1 220 and the DTV1 230 belong to a cluster A 210, while the PVR2 250 and the DTV2 260 belong to a cluster B 240. The PVR1 220 and the PVR2 250 access and decode contents, render decoded data, and transmit the data to the DTV1 230 and the DTV2 260, respectively, via cables.

FIG. 3 is a diagram illustrating a method of using content between a related source device 320 and a related sync device 310.

Referring to FIG. 3, if the sync device 310 requests the source device 320 for playback of content (operation 330), the source device 320 authenticates whether the source device 320 is authorized to access the content (operation 340). If the source device 320 is authorized to access the content, the source device 320 transmits a stream of the content to the sync device 310 (operation 350). The sync device 310 then receives and plays back the stream of the content (operation 360).

Referring back to FIG. 2, the DTV1 230, which is a sync device, and the PVR2 250, which is a source device, do not belong to the same cluster. However, if the DTV1 230 requests the PVR2 250 for a content stream B, the PVR2 250 transmits the stream of the content B to the DTV1 230, because the PVR2 250 is authorized to access the content B. Therefore, the DTV1 230 belonging to the cluster A 210 can play back the content B.

As stated above, an apparatus accessing content is assumed to decode and render content in a related method. However, the related method is unable to prevent content from spreading to other clusters illegally if a source device transmitting a stream of the content and a sync device playing back the content are separated.

### SUMMARY OF THE INVENTION

The present invention provides a method and apparatus for using content and controlling use of content in a cluster in a source device and a sync device to prevent illegal transmission of content from a cluster to other clusters, a method and apparatus for authenticating authorization to access content, and a computer readable medium having recorded thereon a computer program for executing the methods.

According to an aspect of the present invention, there is provided a method of controlling use of content in a cluster, the method including receiving a request from a sync device to transmit content, authenticating whether a cluster to which the sync device belongs is authorized to access the content, and transmitting a stream of the content to the sync device.

The method of controlling use of content in a cluster may further include authenticating whether a cluster to which the source device belongs is authorized to access the content.

The authentication of whether the cluster to which the source device belongs is authorized to access the content may include comparing an identification (ID) of the cluster to which the source device belongs and an ID of a cluster in which the content is authorized to be used.

The authentication of whether the cluster to which the sync device belongs is authorized to access the content may include transmitting a random number and the ID of the cluster in which the content is authorized to be used to the sync device, receiving the random number, the ID of the cluster in which the content is authorized to be used, additional information, and an electronic signature of the sync device, generated based on the random number, the ID of the cluster in which the content is authorized to be used, and the additional information, from the sync device, and authenticating the electronic signature of the sync device by using a secret key of the cluster to which the source device belongs.

The authentication of whether the cluster to which the sync device belongs is authorized to access the content may further include generating an electronic signature of the source device based on the random number and the ID of the cluster in which the content is authorized to be used by using the secret key of the cluster to which the source device belongs, and transmitting the electronic signature of the source device to the sync device.

According to another aspect of the present invention, there is provided an apparatus of controlling use of content in a cluster, the apparatus is included in a source device, and includes a receiving unit which receives a request from a sync device to transmit content, a sync authenticating unit which authenticates whether a cluster to which the sync device belongs is authorized to access the content, and a transmitting unit which transmits a stream of the content to the sync device.

According to another aspect of the present invention, there is provided an apparatus using content in a cluster, the apparatus is included in a sync device, and includes a transmitting unit which requests a source device to transmit content, a sync authenticating unit which authenticates whether a cluster to which the sync device belongs is authorized to access the content, and a receiving unit which receives a stream of the content from the source device.

According to another aspect of the present invention, there is provided a computer readable medium having recorded thereon a computer program for executing a method of controlling use of content in a cluster, wherein the content is used by a source device, the method including receiving a request from a sync device to transmit content, authenticating whether a cluster to which the sync device belongs is authorized to access the content, and transmitting a stream of the content to the sync device.

According to another aspect of the present invention, there is provided a computer readable medium having recorded thereon a computer program for executing a method of controlling use of content in a cluster, wherein the content is used by a sync device, the method including requesting a source device to transmit content, authenticating whether a cluster to which the sync device belongs is authorized to access the content, and receiving a stream of the content from the source device.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of a related system for controlling use of content in a cluster;

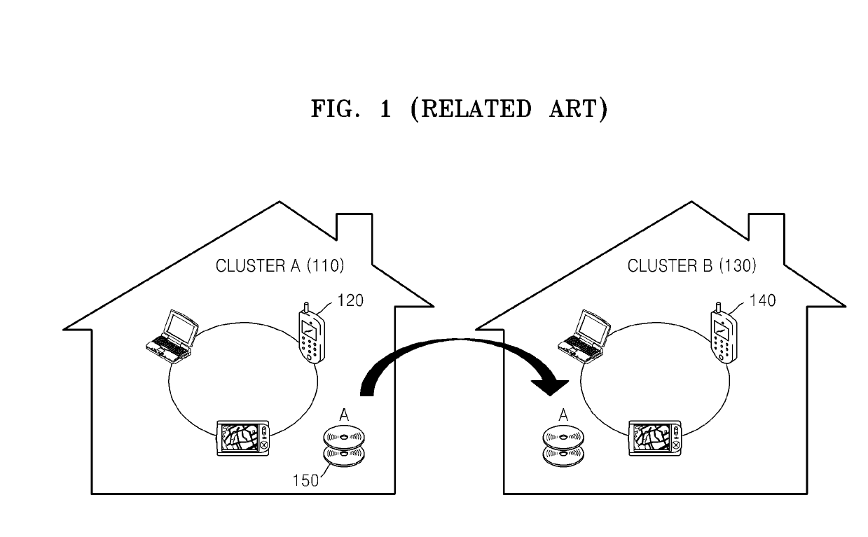

FIG. 2 is a diagram for explaining problems of the related system for controlling use of content in a cluster;

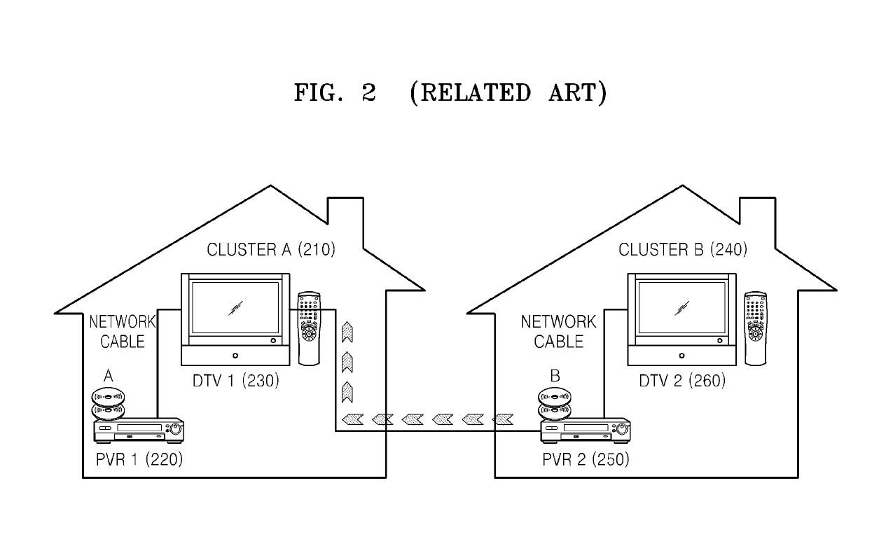

FIG. 3 is a diagram illustrating a method of using content between a related source device and a related sync device;

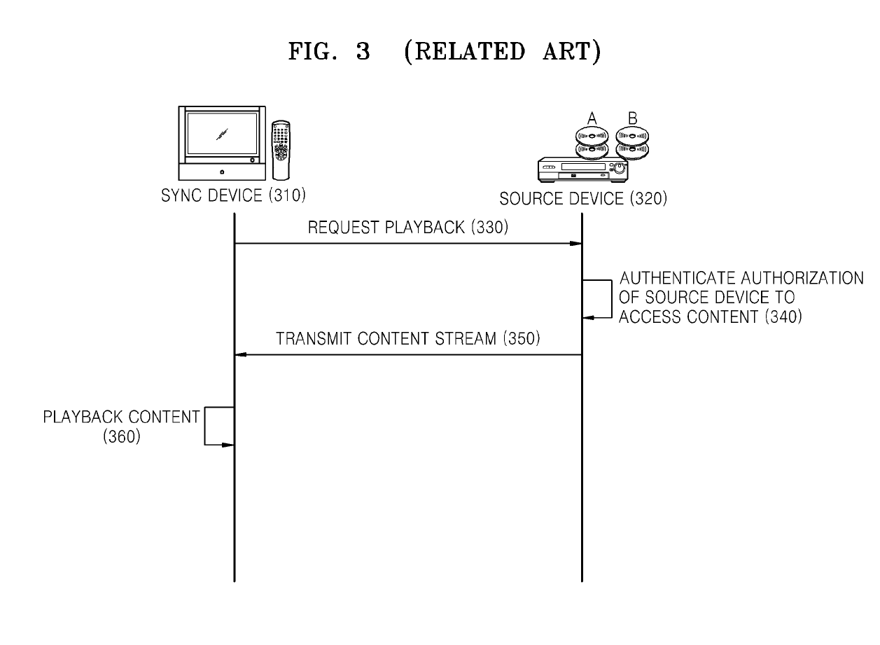

FIG. 4 is a diagram illustrating a method of using content between a source device and a sync device, according to an exemplary embodiment of the present invention;

FIG. 5 is a diagram illustrating an example in which an electronic signature is generated by the sync device of FIG. 4, according to an exemplary embodiment of the present invention;

FIG. 6 is a diagram illustrating a method of using content in a multi-cluster environment, according to another exemplary embodiment of the present invention;

FIG. 7 is a block diagram of an apparatus for controlling use of content in a cluster, wherein the apparatus is included in a source device, according to an exemplary embodiment of the present invention;

FIG. 8 is a block diagram of an apparatus for using content in a cluster, wherein the apparatus is included in a sync device, according to an exemplary embodiment of the present invention;

FIG. 9 is a flowchart illustrating a method of controlling use of content in a cluster by a source device, according to an exemplary embodiment of the present invention;

FIG. 10 is a flowchart illustrating a method of authenticating a cluster to which a source device belongs. according to an exemplary embodiment of the present invention;

FIG. 11 is a flowchart illustrating a method of controlling use of content in a cluster by a sync device, according to an exemplary embodiment of the present invention; and

FIG. 12 is a flowchart showing a method of authenticating a cluster to which a sync device belongs, according to an exemplary embodiment of the present invention.

### DETAILED DESCRIPTION OF THE INVENTION

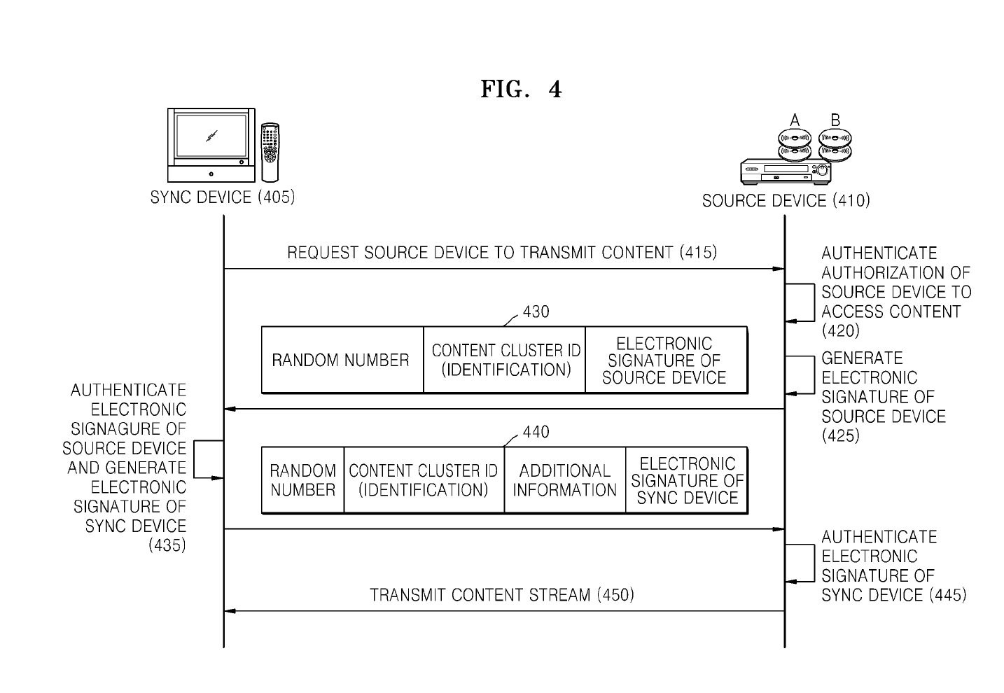

FIG. 4 is a diagram illustrating a method of using content between a source device 410 and a sync device 405, according to an exemplary embodiment of the present invention. The current exemplary embodiment relates to limiting content such that the content can only be used within authorized clusters. For example, if a sync device belonging to a cluster A requests a source device belonging to the cluster A to transmit content to the sync device, the source device authenticates whether the sync device A is authorized to access the content before transmitting the content to the sync device. If the authentication fails, the content is not sent to the sync device.

Referring to FIG. 4, the sync device 405 requests the source device 410 to transmit content for playback to the sync device 405 (operation 415).

Once the source device 410 receives the request to transmit the content from the sync device 405, the source device 410 authenticates whether a cluster to which the source device 410 belongs is authorized to access the content (operation 420). For the authentication, the source device 410 may compare an ID of the cluster to which the source device 410 belongs and an ID of a cluster in which the content is authorized to be used (henceforth a content cluster ID).

According to an exemplary embodiment of the present invention, content includes an ID of a cluster in which the content is authorized to be used, that is, a content cluster ID. Therefore, if an ID of a cluster to which the source device 410 belongs is identical to a content cluster ID, the source device 410 determines that the source device 410 is authorized to access the requested content. In contrast, if the ID of the cluster to which the source device 410 belongs is different from the content cluster ID, the source device 410 determines that the source device 410 is not authorized to access the requested content and terminates the process.

Once the source device 410 determines that the cluster to which the source device 410 belongs is authorized to access the requested content, the source device 410 authenticates whether a cluster to which the sync device 405 belongs is authorized to access the content. For the authentication, the source device 410 generates a random number, extracts the content cluster ID from the content, and transmits the random number and the content cluster ID to the sync device 405 (operation 430).

Also, the source device 410 may generate an electronic signature of the source device 410 (operation 425), and may transmit the electronic signature to the sync device 405 with the random number and the content cluster ID. The electronic signature of the source device 410 is generated based on the random number and the content cluster ID by using a secret key code of the cluster to which the source device 410 belongs.

The sync device 405 receives the random number, the content cluster ID, and electronic signature of the source device 410 from the source device 410. The electronic signature of the source device 410 may or may not be received according to exemplary embodiments of the present invention. Once the electronic signature of the source device 410 is received, the sync device 405 authenticates the electronic signature of the source device 410 by using a secret key code of the cluster to which the sync device 405 belongs (operation 435). In other words, the sync device 405 generates an electronic signature based on the random number and the content cluster ID, both of which are received from the source device 410, by using a secret key code of the cluster to which the sync device 405 belongs. The sync device 405 then compares the generated electronic signature to the electronic signature of the source device 410. If the generated electronic signature is identical to the electronic signature of the source device 410, the source device 410 is successfully authenticated.

The sync device 405 generates an electronic signature of the sync device 405 based on the random number, the content cluster ID, both of which are received from the source device 410, and predetermined additional information, by using the secret key of the cluster to which the sync device 405 belongs.

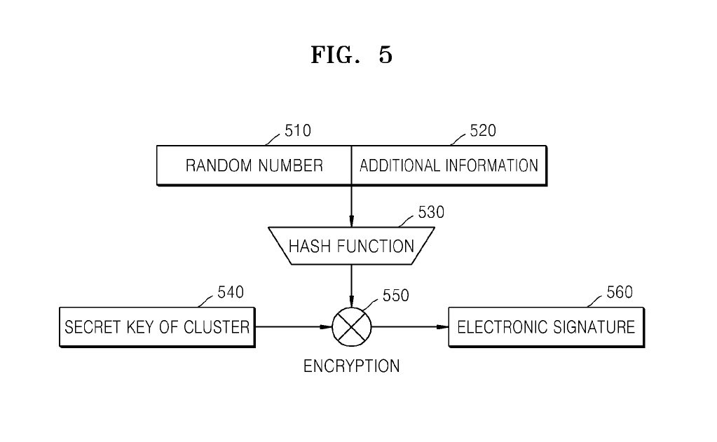

FIG. 5 is a diagram illustrating an example in which an electronic signature 560 is generated by the sync device 405 of FIG. 4, according to an exemplary embodiment of the present invention.

Referring to FIG. 5, hash functions of a random number 510, a content cluster ID, and additional information 520 are calculated (operation 530), wherein the additional information may be an ID of the sync device 405. The calculated hash functions are encrypted by using a secret key 540 of the cluster to which the sync device 405 belongs (operation 550), and thus the electronic signature 560 is generated.

The additional information 520 may be the ID of the sync device 405 or may be other information randomly generated by the sync device 405. The main purpose of including additional information is to prevent a case in which data sent from the source device 410 to the sync device 405 and data sent from the sync device 405 to the source device 410 are identical.

Referring back to FIG. 4, the sync device 405 transmits the random number, the content cluster ID, the additional information, and the electronic signature of the sync device 405 to the source device 410 (operation 440).

The source device 410 receives the random number, the content cluster ID, the additional information, and the electronic signature of the sync device 405 from the sync device 405. The source device 410 then authenticates the electronic signature of the sync device 405 by using the secret key of the cluster to which the source device 410 belongs (operation 445).

In other words, the electronic signature of the sync device 405 is generated by the sync device 405, and the source device 410 which received the electronic signature of the sync device 405 generates an electronic signature again to authenticate whether the generated electronic signature is identical to the electronic signature of the sync device 405. Also, when the source device 410 authenticates the electronic signature of the sync device 405, the source device 410 must authenticate whether the random number and the content cluster ID received from the sync device 405 are identical to the random number and the content cluster ID sent to the sync device 405.

Once the electronic signature of the sync device 405 is successfully authenticated, the source device 410 transmits a stream of the content to the sync device 405 (operation 450).

In the authentication of a cluster to determine whether the cluster is authorized to access content according to an exemplary embodiment of the present invention, a source device becomes a subject of the authentication while a sync device becomes an object of the authentication. If a sync device such as a digital television (DTV) transmits a request of playing back a specific content to a source device such as a personal video recorder (PVR), the source device generates and transmits a random number with an ID of a cluster to which the content belongs, and requests the sync device to generate and transmit an electronic signature. In response to the request, the sync device transmits the random number and the additional information back to the source device with an electronic signature for the data sent back to indicate that the sync device normally belongs to the cluster. The source device authenticates whether the electronic signature received from the sync device is valid, and then authenticates whether an ID of the cluster to which the sync device is assigned to and an ID of the cluster to which the content is assigned to are identical.

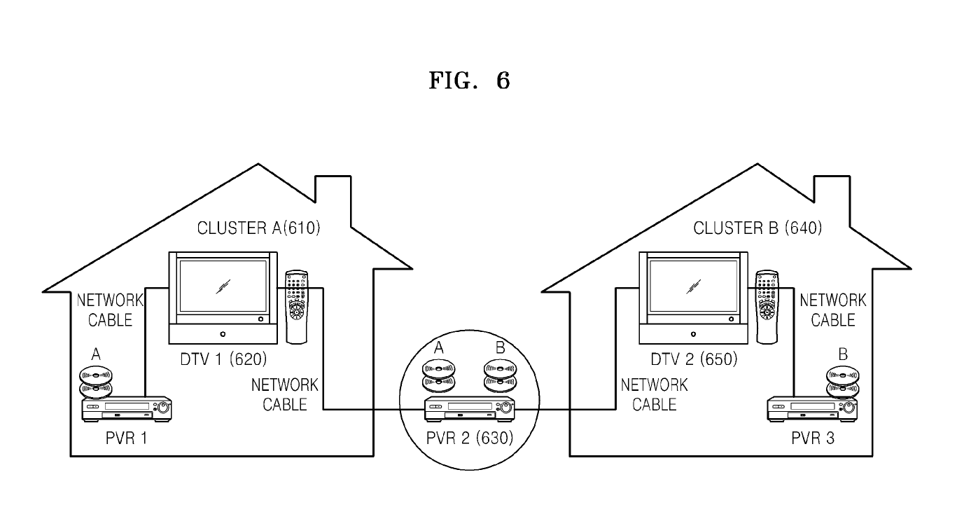

FIG. 6 is a diagram illustrating a method of using content in a multi-cluster environment, according to another exemplary embodiment of the present invention.

Referring to FIG. 6, a source device 630 such as a PVR2 belongs to a plurality of clusters. Conventionally, sync devices DTV1 620 and DTV2 650 respectively belonging to a cluster A 610 and a cluster B 640 can play back both a content A and a content B via the source device 630, since the source device 630 can access contents belonging to both the cluster A 610 and the cluster B 640.

However, according to the exemplary embodiment of the present invention, the sync device DTV1 620 belonging to the cluster A 610 can only receive the content A belonging to the cluster A 610, and cannot receive the content B belonging to the cluster B 640. Similarly, the sync device DTV2 650 belonging to the cluster B 640 can only receive the content B belonging to the cluster B 640, and cannot receive the content A belonging to the cluster A 610.

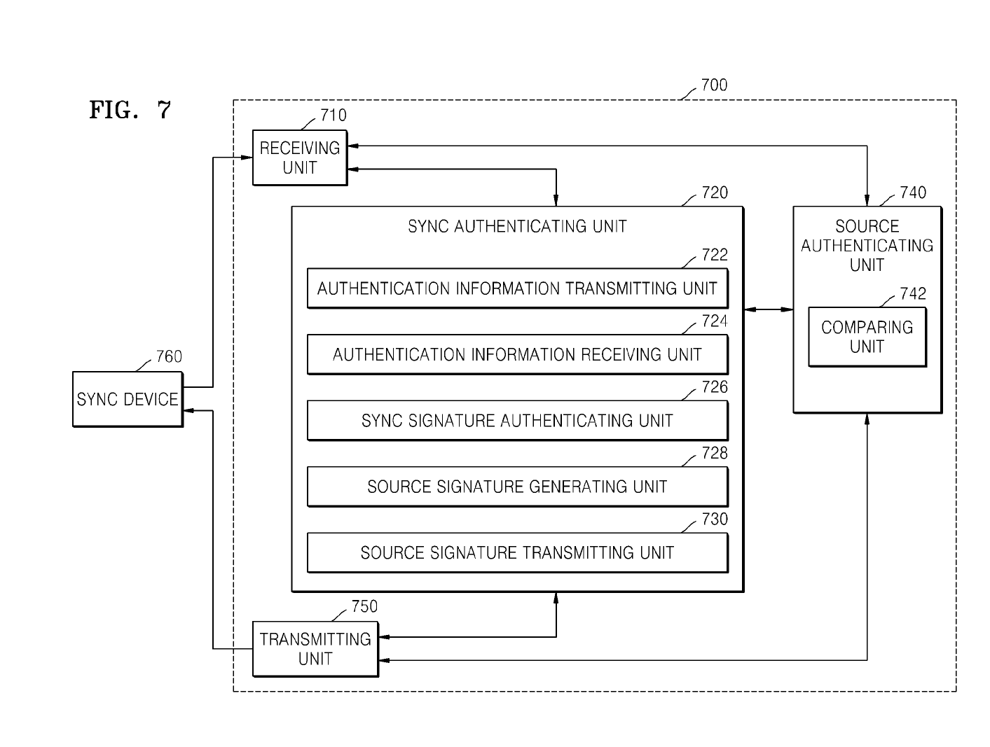

FIG. 7 is a block diagram of an apparatus for controlling use of content in a cluster 700, wherein the apparatus is included in a source device, according to an exemplary embodiment of the present invention.

Referring to FIG. 7, the apparatus for controlling use of content in a cluster 700 according to the current exemplary embodiment, includes a receiving unit 710, a sync authenticating unit 720, a transmitting unit 750, and a source authenticating unit 740.

The receiving unit 710 receives a request to transmit content from a sync device 760.

The sync authenticating unit 720 authenticates whether a cluster to which the sync device 760 belongs is authorized to access the content. The sync authenticating unit 720 includes an authentication information transmitting unit 722, an authentication information receiving unit 724, a sync signature authenticating unit 726, and may further include a source signature generating unit 728 and a source signature transmitting unit 730.

The authentication information transmitting unit 722 generates a random number and extracts a content cluster ID from the requested content. The authentication information transmitting unit 722 then transmits the random number and the content cluster ID to the sync device 760 via the transmitting unit 750.

The authentication information receiving unit 724 receives the random number, the content cluster ID, additional information, and an electronic signature of the sync device 760, generated based on the random number, the content cluster ID, and the additional information, from the sync device 760 via the receiving unit 710.

The sync signature authenticating unit 726 authenticates the electronic signature of the sync device 760, which is received by the authentication information receiving unit 724, by using a secret key of a cluster to which a source device belongs.

Meanwhile, the source signature generating unit 728 generates an electronic signature of the source device based on a random number and the content cluster ID by using the secret key of the cluster to which the source device belongs.

The source signature transmitting unit 730 transmits the electronic signature of the source device to the sync device 760 via the transmitting unit 750.

Once the electronic signature of the sync device 760 is successfully authenticated in the sync signature authenticating unit 726, the transmitting unit 750 transmits a stream of the content requested by the sync device 760 to the sync device 760.

The source authenticating unit 740 authenticates whether the cluster to which the source device belongs is authorized to access the content. The source authenticating unit 740 may include a comparing unit 742 comparing an ID of the cluster to which the source device belongs and the content cluster ID.

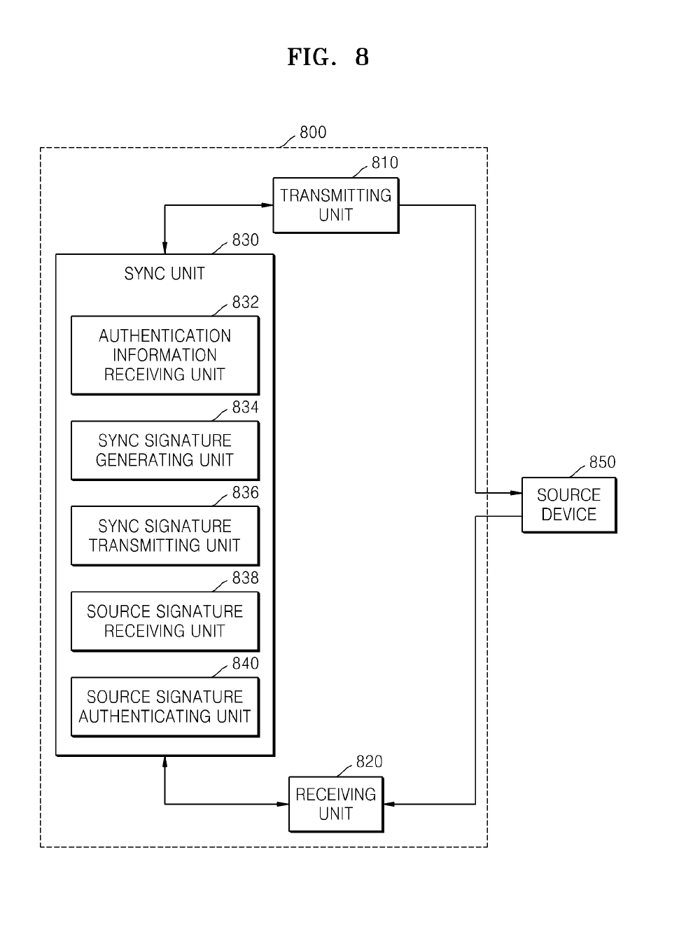

FIG. 8 is a block diagram of an apparatus using content in a cluster 800, wherein the apparatus is included in a sync device, according to an exemplary embodiment of the present invention.

Referring to FIG. 8, the apparatus using content in a cluster 800 according to the current exemplary embodiment includes a transmitting unit 810, a sync authenticating unit 830, and a receiving unit 820.

The transmitting unit 810 requests a source device 850 to transmit content.

The sync authenticating unit 830 authenticates whether a cluster to which a sync device belongs is authorized to access the content. The sync authenticating unit 830 includes an authentication information receiving unit 832, a sync signature generating unit 834, a sync signature transmitting unit 836, and may further include a source signature receiving unit 838 and a source signature authenticating unit 840.

The authentication information receiving unit 832 receives a random number and a content cluster ID from the source device 850 via the receiving unit 820.

The sync signature generating unit 834 generates an electronic signature of the sync device based on the random number, the content cluster ID, and additional information by using a secret key of the cluster to which the sync device belongs. The additional information may be either an ID of the sync device or other information.

The sync signature transmitting unit 836 transmits the random number, the content cluster ID, the additional information, and the signature of the sync device to the source device 850 via the transmitting unit 810.

The source signature receiving unit 838 receives the electronic signature of the source device 850, which is generated based on the random number and the content cluster ID, via the receiving unit 820.

The source signature authenticating unit 840 authenticates the electronic signature of the source device 850 by using the secret key of the cluster to which the sync device belongs.

The receiving unit 820 receives a stream of the requested content from the source device 850 if the authentication is successful.

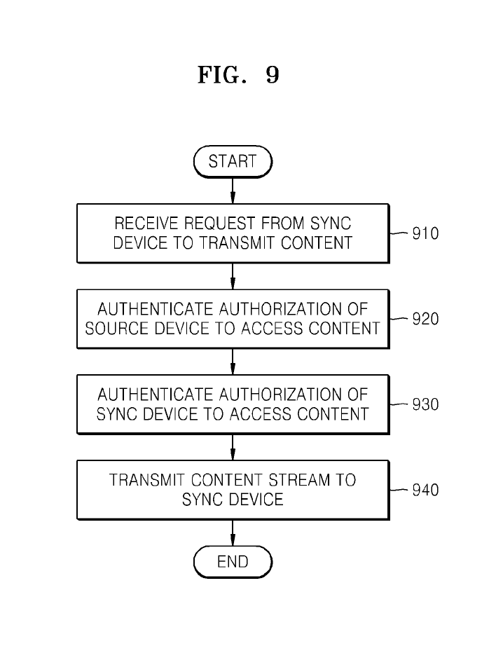

FIG. 9 is a flowchart illustrating a method of controlling use of content in a cluster by a source device, according to an exemplary embodiment of the present invention.

Referring to FIG. 9, the source device receives a request from a sync device to transmit content in operation 910.

In operation 920, the source device authenticates whether a cluster to which the source device belongs is authorized to access the content. For example, the source device may perform the authentication by comparing an ID of the cluster to which the source device belongs and a content cluster ID. According to exemplary embodiments of the present invention, the operation 920 may be omitted.

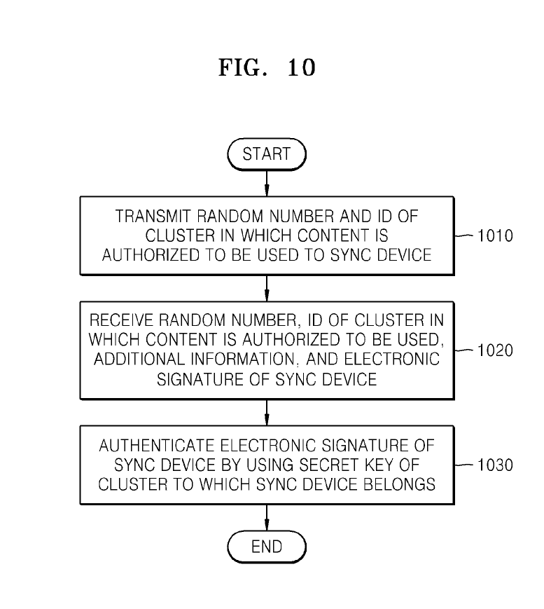

In operation 930, the source device authenticates whether a cluster to which the sync device belongs is authorized to access the content. A method of performing such authentication is illustrated in FIG. 10.

FIG. 10 is a flowchart illustrating a method of authenticating whether a cluster to which a source device belongs is authorized to access content, according to an exemplary embodiment of the present invention.

Referring to FIG. 10, the source device generates a random number, extracts a content cluster ID from content, and transmits the random number and the content cluster ID to the sync device, in operation 1010.

Also, the source device can generate an electronic signature of the source device based on the random number and the content cluster ID by using a secret key of the cluster to which the source device belongs. In this case, the source device transmits the electronic signature of the source device to the sync device.

The source device receives the random number, the content cluster ID, additional information, and an electronic signature of the sync device generated based on the random number, the content cluster ID, and the additional information from the sync device in operation 1020.

The source device authenticates the electronic signature of the sync device by using the secret key of the cluster to which the source device belongs in operation 1030.

Referring back to FIG. 9, the source device transmits a stream of the requested content to the sync device if the electronic signature of the sync device is successfully authenticated in operation 940.

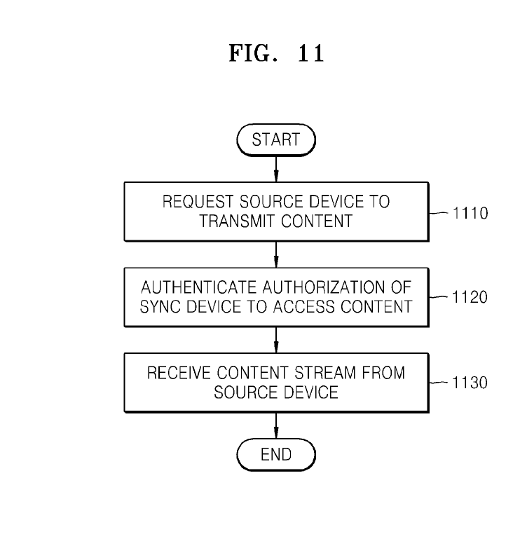

FIG. 11 is a flowchart illustrating a method of using content in a cluster by a sync device, according to an exemplary embodiment of the present invention.

Referring to FIG. 11, the sync device requests a source device to transmit content in operation 1110.

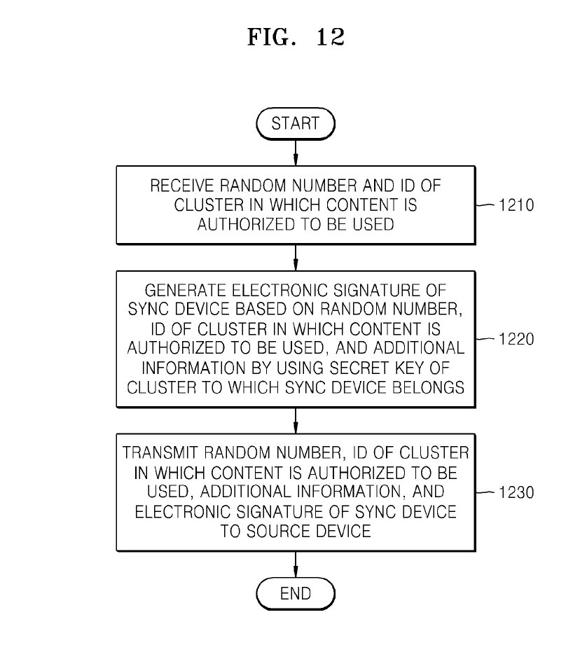

The sync device authenticates whether a cluster to which the sync device belongs is authorized to access the requested content in operation 1120. A method of performing such authentication is illustrated in FIG. 12.

Referring to FIG. 12, the sync device receives a random number and a content cluster ID in operation 1210. Also, the sync device may receive an electronic signature of the source device generated based on the random number and the content cluster ID from the source device. In this case, the sync device authenticates the electronic signature of the source device by using a secret key of the cluster to which the sync device belongs.

The sync device generates an electronic signature of the sync device based on the random number, the content cluster ID, and additional information by using the secret key of the cluster to which the sync device belongs, in operation 1220.

The sync device transmit the random number, the content cluster ID, the additional information, and the electronic signature of the sync device to the source device in operation 1230.

Referring back to FIG. 11, if the authorization to access the content requested in the operation 1120 is successfully authenticated, the sync device receives a stream of the requested content from the source device in operation 1130.

The method of using and controlling content in a cluster by a source device and a sync device and the method of authenticating an authorization to access content according to the exemplary embodiments of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling use of content in a cluster by a source device, the method comprising:
receiving a request from a sync device to transmit content;
authenticating whether a cluster to which the sync device belongs is authorized to access the content; and
transmitting a stream of the content to the sync device.

2. The method of claim 1, further comprising authenticating whether a cluster to which the source device belongs is authorized to access the content.

3. The method of claim 2, wherein the authenticating of whether the cluster to which the source device belongs is authorized to access the content comprises comparing an identification (ID) of the cluster to which the source device belongs and an ID of a cluster in which the content is authorized to be used.

4. The method of claim 3, wherein the authenticating of whether the cluster to which the sync device belongs is authorized to access the content comprises:
transmitting a random number and the ID of the cluster in which the content is authorized to be used to the sync device;
receiving the random number, the ID of the cluster in which the content is authorized to be used, additional information, and an electronic signature of the sync device, generated based on the random number, the ID of the cluster in which the content is authorized to be used, and the additional information from the sync device; and
authenticating the electronic signature of the sync device by using a secret key of the cluster to which the source device belongs.

5. The method of claim 4, wherein the authenticating of whether the cluster to which the sync device belongs is authorized to access the content further comprises:
generating an electronic signature of the source device based on the random number and the ID of the cluster in which the content is authorized to be used, by using the secret key of the cluster to which the source device belongs; and
transmitting the electronic signature of the source device to the sync device.

6. The method of claim 4, wherein the additional information comprises an ID of the sync device.

7. A method of authenticating whether a cluster to which a source device belongs is authorized to access content, the method comprising:
transmitting a random number and an identification (ID) of a cluster in which the content is authorized to be used to a sync device;
receiving the random number, the ID of the cluster in which the content is authorized to be used, additional information, and an electronic signature of the sync device, generated based on the random number, the ID of the cluster in which the content is authorized to be used, and the additional information from the sync device; and
authenticating the electronic signature of the sync device by using a secret key of a cluster to which the source device belongs.

8. A method of using content in a cluster by a sync device, the method comprising:
requesting a source device to transmit content;
authenticating whether a cluster to which the sync device belongs is authorized to access the content; and
receiving a stream of the requested content from the source device.

9. The method of claim 8, wherein the authenticating of whether a cluster to which the sync device belongs is authorized to access the content comprises:
receiving a random number and an identification (ID) of a cluster in which the content is authorized to be used;
generating an electronic signature of the sync device based on the random number, the ID of the cluster in which the content is authorized to be used, and additional information by using a secret key of the cluster to which the sync device belongs; and
transmitting the random number, the ID of the cluster in which the content is authorized to be used, the additional information, and the electronic signature of the sync device.

10. The method of claim 9, wherein the authenticating of whether a cluster to which the sync device belongs is authorized to access the content further comprises:
receiving an electronic signature of the source device generated based on the random number and the ID of the cluster in which the content is authorized to be used; and
authenticating the electronic signature of the source device by using the secret key of the cluster to which the sync device belongs.

11. The method of claim 9, wherein the additional information comprises an ID of the sync device.

12. A method of authenticating whether a cluster to which a sync device belongs is authorized to access content, the method comprising:
receiving a random number and an identification (ID) of a cluster in which the content is authorized to be used from a source device;
generating an electronic signature of the sync device based on the random number, the ID of the cluster in which the content is authorized to be used, and additional information by using a secret key of the cluster to which the sync device belongs; and
transmitting the random number, the ID of the cluster in which the content is authorized to be used, the additional information, and the electronic signature of the sync device to the source device.

13. An apparatus for controlling use of content in a cluster, the apparatus being included in a source device, and comprising:
a receiving unit which receives a request from a sync device to transmit content;
a sync authenticating unit which authenticates whether a cluster to which the sync device belongs is authorized to access the content; and
a transmitting unit which transmits a stream of the content to the sync device.

14. The apparatus of claim 13, further comprising a source authenticating unit which authenticates whether a cluster to which the source device belongs is authorized to access the content.

15. The apparatus of claim 14, wherein the source authenticating unit comprises a comparing unit which compares an identification (ID) of the cluster to which the source device belongs and an ID of a cluster in which the content is authorized to be used.

16. The apparatus of claim 15, wherein the sync authenticating unit comprises:
an authentication information transmitting unit which transmits a random number and the ID of a cluster in which the content is authorized to be used to the sync device;
an authentication information receiving unit which receives the random number, the ID of the cluster in which the content is authorized to be used, additional information, and an electronic signature of the sync device, generated based on the random number, the ID of the cluster in which the content is authorized to be used, and the additional information, from the sync device; and
a sync signature authenticating unit which authenticates the electronic signature of the sync device by using a secret key of the cluster to which the source device belongs.

17. The apparatus of claim 16, wherein the sync authenticating unit further comprises:
a source signature generating unit which generates an electronic signature of the source device based on the random number and the ID of the cluster in which the content is authorized to be used by using the secret key of the cluster to which the source device belongs; and
a source signature transmitting unit which transmits the electronic signature of the source device to the sync device.

18. The apparatus of claim 16, wherein the additional information comprises an ID of the sync device.

19. An apparatus for authenticating whether a cluster to which a source device belongs is authorized to access content, the apparatus comprising:
a transmitting unit which transmits a random number and an identification (ID) of a cluster in which the content is authorized to be used;
a receiving unit which receives the random number, the ID of the cluster in which the content is authorized to be used, additional information, and an electronic signature of a sync device, generated based on the random number, the ID of the cluster in which the content is authorized to be used, and the additional information, from the sync device; and
authenticating the electronic signature of the sync device by using a secret key of the cluster to which the source device belongs.

20. An apparatus for using content in a cluster, the apparatus being included in a sync device, and comprising:
a transmitting unit which requests a source device to transmit content;
a sync authenticating unit which authenticates whether a cluster to which the sync device belongs is authorized to access the content; and
a receiving unit which receives a stream of the content from the source device.

21. The apparatus for using content in a cluster of claim 20, wherein the sync authenticating unit comprises:
an authentication information receiving unit which receives a random number and an identification (ID) of a cluster in which the content is authorized to be used from the source device;
a sync signature generating unit which generates an electronic signature of the sync device based on the random number, the ID of the cluster in which the content is authorized to be used, and additional information by using a secret key of the cluster to which the sync device belongs; and
a transmitting unit which transmits the random number, the ID of the cluster in which the content is authorized to be used, the additional information, and the electronic signature of the sync device to the source device.

22. The apparatus for using content in a cluster of claim 21, wherein the sync authenticating unit further comprises:
a source signature receiving unit which receives an electronic signature of the source device generated based on the random number and the ID of the cluster in which the content is authorized to be used; and
a source signature authenticating unit which authenticates the electronic signature of the source device by using a secret key of the cluster to which the sync device belongs.

23. The apparatus for using content in a cluster of claim 21, wherein the additional information is an ID of the sync device.

24. An apparatus authenticating whether a cluster to which a sync device belongs is authorized to access content, the apparatus comprising:
an authentication information receiving unit which receives a random number and an ID of a cluster in which the content is authorized to be used from a source device;
a sync signature generating unit which generates an electronic signature of the sync device based on the random number, the ID of the cluster in which the content is authorized to be used, and additional information by using a secret key of the cluster to which the sync device belongs; and
a sync signature transmitting unit which transmits the random number, the ID of the cluster in which the content is authorized to be used, the additional information, and the electronic signature of the sync device.

25. A computer readable medium having recorded thereon a computer program for executing a method of controlling use of content in a cluster, wherein the content is used by a source device, the method comprising:
receiving a request from a sync device to transmit content;
authenticating whether a cluster to which the sync device belongs is authorized to access the content; and
transmitting a stream of the content to the sync device.

26. A computer readable medium having recorded thereon a computer program for executing a method of controlling use of content in a cluster, wherein the content is used by a sync device, the method comprising:
requesting a source device to transmit content;
authenticating whether a cluster to which the sync device belongs is authorized to access the content; and
receiving a stream of the content from the source device.
